(19) United States
(12) Patent Application Publication
(10) Pub. No.: US 2026/0131891 A1
(43) Pub. Date: May 14, 2026

(54) DRONE FOR SPRAYING AND BROOMING A CONCRETE SURFACE

(71) Applicant: Somero Enterprises, Inc., Fort Myers, FL (US)

(72) Inventors: Jason Myers, Lancaster, KS (US); Adam Madison, Lancaster, KS (US)

(21) Appl. No.: 19/371,119

(22) Filed: Oct. 28, 2025

Related U.S. Application Data
(60) Provisional application No. 63/719,157, filed on Nov. 12, 2024.

(51) Int. Cl. B64D 1/18; B64U 10/14; B64U 20/80; B64U 50/30; B64U 60/50; B64U 101/45; E01C 19/17

(52) U.S. Cl. CPC B64D 1/18; B64U 10/14; B64U 20/80; B64U 50/30; B64U 60/50; E01C 19/176; E01C 19/178; B64U 2101/45; B64U 2201/20

(57) ABSTRACT

A drone includes a body frame and a plurality of boom assemblies. Each boom assembly has a proximal end region disposed at the body frame and a distal end region linearly displaced from the proximal end region. Each propulsion member of a plurality of propulsion members is disposed at the distal end region of one respective boom assembly, and includes a motor and a propeller. When the drone is operated to fly above a concrete surface, the plurality of propulsion members are energized to apply lift to the drone. A fluid tank is disposed at the body frame. A spray bar including a plurality of spray nozzles in fluid communication with the fluid tank is disposed at a lower portion of the body frame. A fluid pump is configured to actuate the plurality of spray nozzles to spray a fluid from the fluid tank onto the concrete surface.

### CROSS REFERENCE TO RELATED APPLICATION

The present application claims the filing benefits of U.S. provisional application, Ser. No. 63/719,157, filed Nov. 12, 2024, which is hereby incorporated herein by reference its entirety.

### BACKGROUND OF THE INVENTION

This invention relates generally to unmanned aerial vehicles (UAVs), also referred to as drones, and more particularly, to a drone specifically configured and programmed to spray a sealer or sealant onto a concrete surface and also includes a cement broom which may be pulled across the concrete surface.

Concrete, though resilient, is porous, allowing water, oil, and other contaminants to penetrate its surface. Over time, this can lead to erosion, discoloration, and even structural issues due to freeze-thaw cycles in colder climates. Applying a sealant creates a protective barrier over the surface, shielding it from moisture, stains, and chemical damage.

While sealants provide protection and enhance the durability of concrete, the application of a textured finish is equally important for ensuring safe and functional surfaces. A smooth, sealed concrete surface, particularly when wet, can become slippery and hazardous. A textured finish, achieved by using a broom or other texturing tools, mitigates this risk by adding traction to the surface.

Applying a sealant and achieving a textured finish on concrete surfaces are essential steps in enhancing both the performance and safety of concrete installations. Sealants offer crucial protection against moisture, stains, and environmental stressors, extending the life and reducing maintenance needs of concrete surfaces. Meanwhile, a broom-textured finish provides the necessary traction to prevent slips, supports efficient water drainage, and improves the surface's visual appeal. Together, these practices contribute to a long-lasting, functional, and attractive concrete surface suitable for various residential, commercial, and industrial applications.

Although presumably effective for their intended purposes, traditional construction techniques are characterized by manual tasks that may require additional equipment, especially if a concrete pad is large in size or has an irregular dimension.

Therefore, it would be desirable to have an unmanned aerial vehicle specifically configured to spray or broadcast a sealer or sealant onto a predetermined confined area such as a concrete surface. Further, it would be desirable to have a UAV that includes a bristled broom that is configured for applying a textured surface to an uncured concrete surface.

### SUMMARY OF THE INVENTION

An unmanned aerial vehicle (UAV) for selectively spraying and brooming a concrete surface according to the present invention includes a body frame and a plurality of boom assemblies coupled to and extending away from the body frame. Further, a plurality of propulsion members is coupled to distal ends of respective boom assemblies, each propulsion member including a motor and a propeller configured to impart lift to the UAV when energized. It is understood that the UAV may be programmed to pass over the exact dimensions of the concrete surface. The UAV may include a receiver for receiving propulsion, navigation, and spray signals from a remote location, the receiver being in data communication with a controller that is configured to control the UAV and specialty components described below.

The UAV may include a power source such as a battery. The drone may include a fluid tank coupled to the body frame, the fluid tank being configured to hold a quantity of a sealer or sealant to be sprayed onto a concrete surface. In addition, a spray bar may be operatively mounted to the body frame and may include a plurality of spray nozzles spaced apart along the spray bar and may include a broadcast spreader. A fluid pump may be in fluid communication with the fluid tank and in data communication with the power source and a controller for selectively actuating the spray nozzles.

In another aspect, the invention may include a broom operatively coupled to the body frame, the broom having a linear and elongate configuration including downwardly oriented bristles. The broom may be positioned rearwardly from the body frame and coupled to a rear edge of the body frame by an arm mount, the arm mount having a leveling assembly that includes a pivot joint that enables the broom to move up and down in response to variations in ground surface topography.

Therefore, a drone is provided that is configured to apply sealant and texture to concrete surfaces.

The drone may have a tank configured to receive and contain a concrete sealer or sealant and having a pump, a plurality of spray nozzles, and control circuitry or programming to dispense the sealant upon a predetermined confined area such as a concrete surface.

The drone may include a concrete broom having a plurality of bristles and a leveling mechanism, said drone being programmable to pull the concrete broom across the predetermined confined area such as a concrete surface.

The drone may have a propulsion assembly that may be programmed to pass over the predetermined boundaries of the confined area according to radio signals regarding navigation, height, speed, flow rate, and the like.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is an elevated perspective view of a drone configured with a sprayer system and texturing tool;

FIG. 1b is another perspective view from a lower angle of the drone as in FIG. 1a;

FIG. 2 is another elevated perspective view of the drone;

FIG. 3 is a perspective view taken from a lower side angle of the drone as in FIG. 2;

FIG. 4 is an isolated side view of a sprayer assembly;

FIG. 5a is a perspective view from a lower angle of the sprayer assembly;

FIG. 5b is an isolated view on an enlarged scale taken from FIG. 5a;

FIG. 6a is a front elevated perspective view of the unmanned aerial vehicle;

FIG. 6b is a rear perspective view of the UAV as in FIG. 6a;

FIG. 7a is an elevated perspective view of the UAV according to another embodiment;

FIG. 7b is an isolated view on an enlarged scale taken from FIG. 7a;

FIG. 7c is an isolated view on an enlarged scale taken from FIG. 7a;

FIG. 8a is a side view of the UAV as in FIG. 7a;

FIG. 8b is a top view of the UAV as in FIG. 8a;

FIG. 9a is a perspective view of a UAV according to another embodiment, illustrated with a pair of concrete brooms arranged in parallel and being pulled behind the UAV;

FIG. 9b is an isolated view on an enlarged scale taken from FIG. 9a;

FIG. 9c is an isolated view on an enlarged scale taken from FIG. 9a;

FIGS. 10a to 10c are isolated perspective views taken from FIG. 9a, illustrating the use of various arrangements of pull assemblies being pulled by the drone; and

FIG. 11 is a logic diagram illustrating the electronic components.

### DESCRIPTION OF THE PREFERRED EMBODIMENT

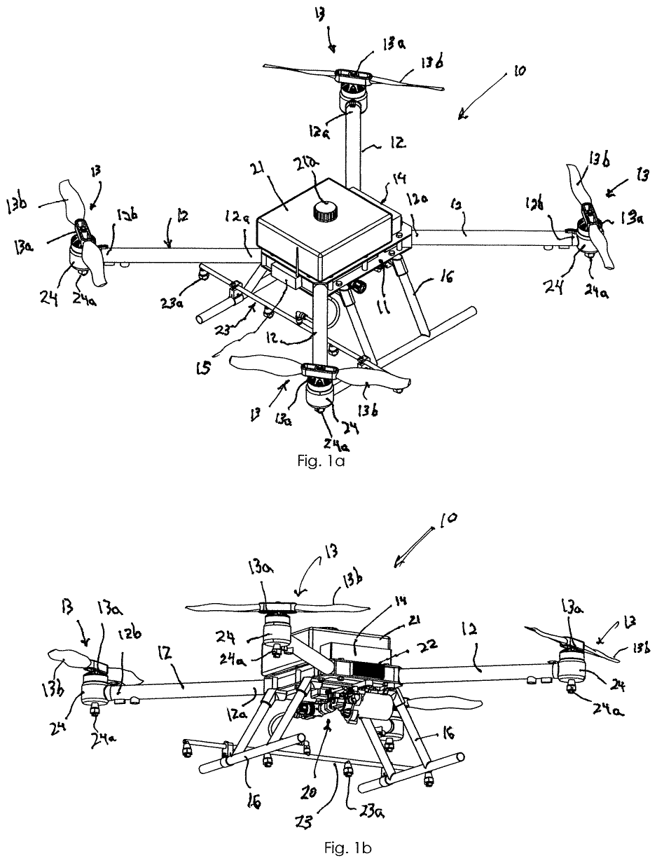

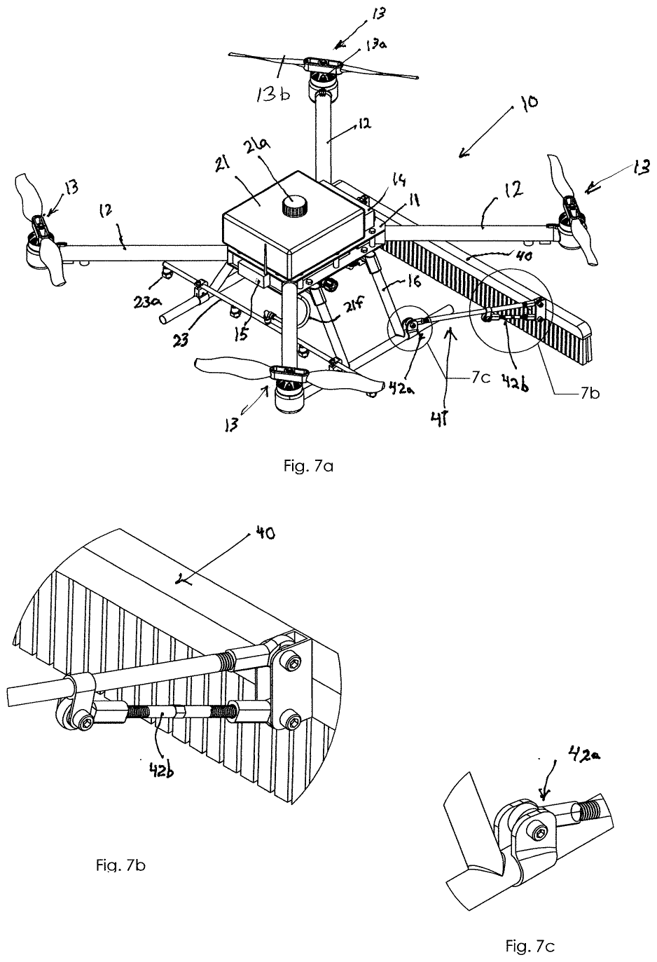

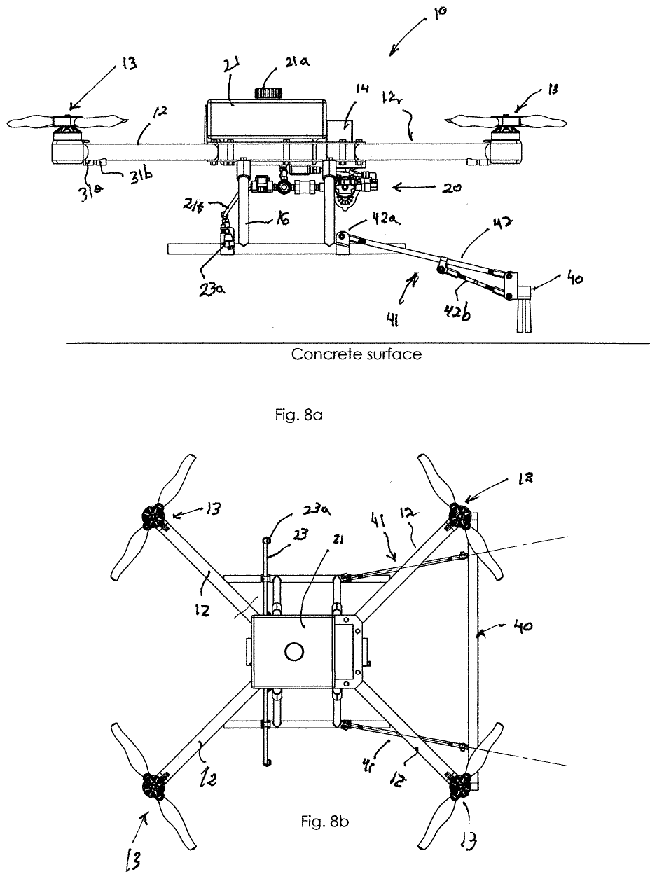

An unmanned aerial vehicle (UAV) for selectively sealing and brooming a concrete surface from an aerial position according to a preferred embodiment of the present invention will now be described with reference to the accompanying drawings. The UAV may be interchangeably referred to as a drone and both terms will be identified using reference character 10 (FIG. 1a). Accordingly, the drone 10 may include a spray assembly 20 (FIG. 1b) and a broom assembly 40 (FIG. 7a).

Utilizing a UAV to apply sealant and texture to concrete surfaces provides a cutting-edge solution that effectively addresses needs of applying a sealant and achieving a textured finish. A UAV equipped with a spraying system and broom-texturing tool may be programmed to match the exact dimensions of the concrete surface, ensuring full coverage with minimal material waste and precision in texturing. This approach offers several compelling benefits that set it apart from traditional manual methods.

Further, applying sealant and creating a textured finish with a UAV may be accomplished far faster than with manual labor. Drones may be programmed to operate in a precise grid or path, covering large surfaces swiftly and consistently. This is especially beneficial in cases where concrete surfaces are extensive, such as in parking lots, sidewalks, or industrial floors. Automated spraying and texturing reduces the time required to complete projects, allowing for faster job turnover and less disruption in areas with heavy foot or vehicle traffic.

A UAV may be pre-programmed with the exact dimensions of a concrete surface, ensuring uniform application of both sealant and texture. This precision means that every area receives the same level of treatment, avoiding potential weak spots or inconsistencies that could lead to wear or water damage. Additionally, the UAV's spray system and broom mechanism may be fine-tuned to control the flow rate and broom angle, ensuring a seamless, high-quality finish across the entire surface.

Generally, the drone 10 includes a main body having upper, lower, front, rear, and side portions which may be referred to for context in the description below, the main body having a body frame 11 to which numerous other components may be coupled or connected directly or indirectly. The drone 10 may include a plurality of boom assemblies 12, each boom assembly having a proximal end 12a and coupled to the body frame 11 and the distal end 12b opposite the proximal end 12a. Preferably, each boom assembly 12 has a linear figuration, and extends outwardly and horizontally away from the body frame 11 and may have a tubular configuration through which a fluid may be communicated as will be described in greater detail later. Preferably, the drone 10 may include at least 3 boom assemblies equally spaced apart from one another although a drone 10 having 4 or more boom assemblies arranged with equal angular displacement extending away from the body frame 11 would also be suitable.

Preferably, the drone may include a plurality of propulsion members 13 operatively mounted to distal ends 12b of boom assemblies 12, respectively, each propulsion member 13 including at least a propulsion motor 13a and a propulsion propeller 13b together configured to lift and steer the drone when energized. The propulsion members 13 may be individually and independently controlled from a remote location and such that the drone will move predictably up, down, left, or right and in combinations thereof.

Further explaining drone navigation, a power source 14 may be coupled to the body frame 11 and may be in electrical communication with the plurality of propulsion numbers 13, such as with wires or wireless communications. Preferably, the power source 14 is a battery although in some embodiments, the power source 14 may include solar collection components, related electronics, or may include a combustion motor and associated liquid fuel source such as gasoline. Further, the drone 10 may include one or more sensors operable in real time to determine a distance at which the drone 10 is situated above the ground. Elevation data may be collected from a laser distance sensor 31a or from a sonic tracer sensor 31b situated on a respective boom assembly 12. This elevation data may be communicated in real time to the remote location from which the drone 10 is being operated so that appropriate control signals may be communicated by an operator. Further, the elevation data may be communicated to onboard circuitry and in communication with programming that is controlling operation of the drone 10 to pass over the dimensions of the concrete surface.

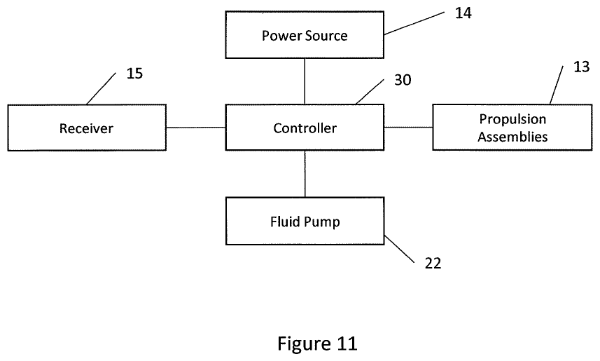

With further regard to navigation and operation of the spray assembly 20 and broom assembly 40, the drone 10 may include a controller 30 (FIG. 11). First, the drone 10 may include a receiver 15, which may be coupled to a front portion of the body frame 11 as is shown in FIG. 1a, the receiver 15 being configured to receive radio signals from a remote location from which the drone 10 is being operated. Preferably, the receiver 15 may be in electrical communication with the power source and may be in data communication with the controller 30 such that the plurality of propulsion members 13 as well as operation of the spray assembly 20 may be controlled by an operator in real time according to the radio signals.

In a first aspect, the drone 10 may include a spray assembly 20, which may also be referred to as a spray module, spray apparatus, sprayer system, or the like. Preferably, the spray assembly 20 includes a fluid tank 21 coupled to an upper portion of the body frame 11. The fluid tank 21 may also be referred to as a reservoir, a sealant tank, or similar combinations thereof. Preferably, a top surface of the fluid tank 11 defines an opening which may be referred to as a fill port and which may be selectively covered by a threaded cap 21a. The tank defines an interior area (i.e., the tank is hollow) configured to receive and hold a predetermined volume or quantity of a liquid sealer or sealant to be sprayed and dispersed onto a defined area such as a concrete pad or concrete surface. In an embodiment, the fluid tank 21 may be constructed of a generally transparent or translucent material having graduated lines indicative of volumetric measurement such that the fluid tank 21 may be filled with a precise volume of liquid to be sprayed.

Still further, the spray assembly 20 may include a spray bar mount 23 indirectly coupled to the body frame 11, the spray bar mount having a linear and tubular configuration (such as a pipe or conduit) including a plurality of spray nozzles 23a spaced apart from one another and distributed therealong (FIG. 1a). The spray bar mount 23 is preferably in fluid communication with the fluid tank 21 and may be in data communication with the controller 30 or other components of the spray assembly 20 such that the liquid sealant may be dispensed through respective nozzles 23a when actuated. In an embodiment, each individual nozzle 23a may be pivotally connected to the spray bar mount 23 and in data communication with the controller 30 such that the angle of the nozzle 23a and, specifically, a pivot joint connection between the nozzle 23a and the spray bar mount 23, may be angularly adjusted when actuated by the controller 30.

The spray assembly 20 may also include a fluid pump 22 in data communication with the controller 30 and fluid tank 21, the fluid pump being configured to actuate the liquid stored in the fluid tank 21 when energized by the controller 30. The fluid tank 21 may include an opening that may be selectively or threadably covered by a cap 21a. The spray assembly 20 may include other traditional components such as a tank sump 21b that is configured to extract liquid from the fluid tank 21 and urge it downstream to the fluid pump 22. Further, the flow assembly 20 may include a fluid regulator 21c, a fluid solenoid 21d, and a flow sensor 21e, and a hose 21f configured to channel the fluid to the spray mount bar 23. It is understood that the sealant or sealer may be applied at a predetermined or variable flow rate set by a user.

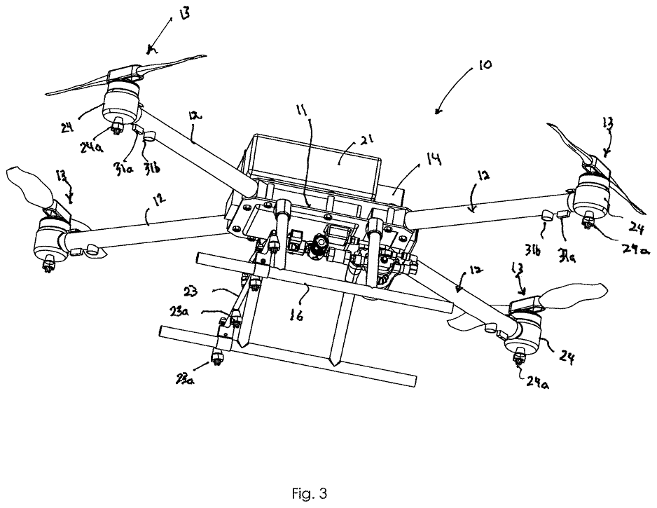

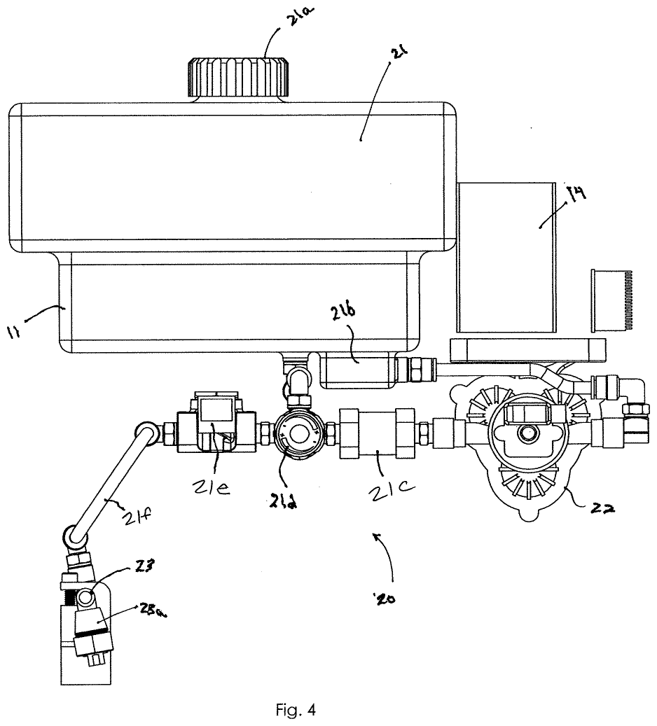

As shown in FIGS. 3, 4 and 5a, the fluid tank 21 may include a first portion disposed at the upper portion or side of the body frame 11 and a second portion that extends at least partially between or within the body frame 11 to be exposed at or near the lower portion or side of the body frame 11. That is, the body frame 11 may comprise a perimeter frame with a hollow or passageway extending between the upper portion and the lower portion. The wider first portion of the fluid tank 21 may extend at least partially outboard of the perimeter frame and couple to the upper portion of the body frame and the narrower second portion of the fluid tank 21 extends from the first portion and inboard or within the perimeter frame. The fluid pump 22 and other components of the spray assembly 20 may be disposed at and coupled to the lower portion of the body frame 11.

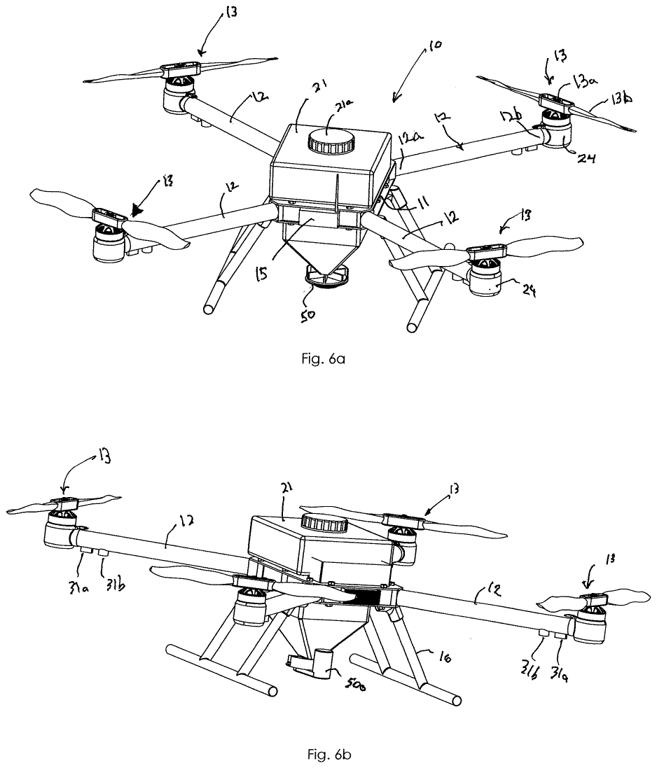

In an embodiment shown in FIGS. 6a and 6b, the fluid tank 21 is actually a dry hopper. Further, the drone 10 may include a broadcast spreader 50 having a broadcast motor 50a. That is, the dry hopper fluid tank 21 is coupled to the upper portion of the body frame 11 and extends at least partially through the body frame 11. The broadcast spreader 50 and broadcast motor 50a are coupled to the dry hopper fluid tank 21 at or below the lower portion of the body frame 11. This embodiment illustrates how the sealant or sealer may be in a dry form such as pellets, fibers, or granular form and then spread via the broadcast spreader 50 in the nature of how grass seed or fertilizer is dispensed.

In an embodiment, the spray assembly 20 may include a plurality of auxiliary spray assemblies 24 coupled to the distal ends 12b of boom assemblies, respectively, each auxiliary spray assembly 24 being in fluid communication with said fluid tank 21 and including a spray tip 24a. It will be understood that the auxiliary spray assemblies 24 may provide a significantly wider and displaced spray pattern that will enable more advanced broadcast of a selected fluid, such as providing a pattern, color, or other indicia upon the concrete surface.

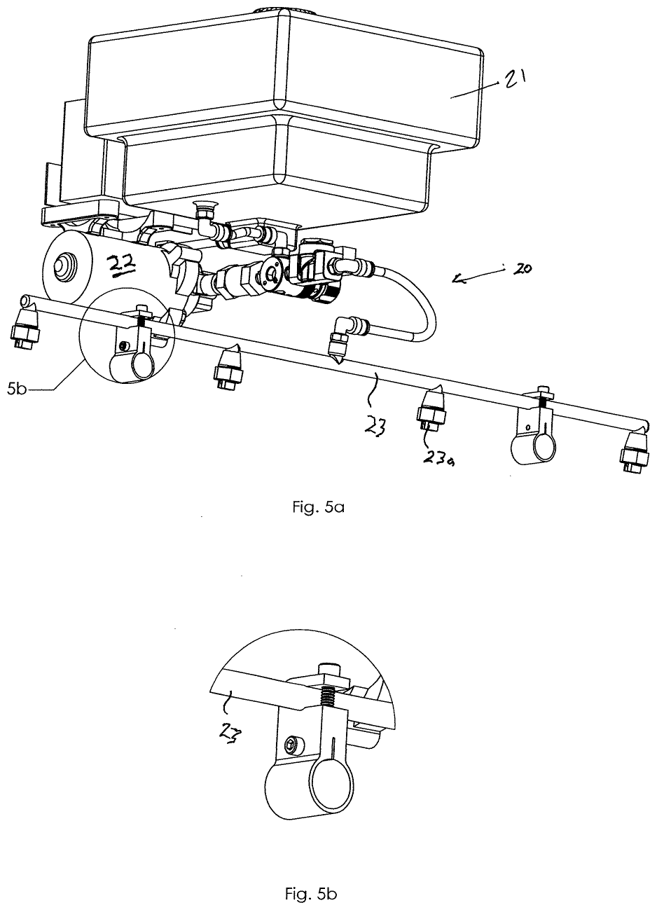

In another aspect, the drone 10 may include a means for supporting itself upon a ground or concrete surface without impacting or damaging the spray bar mount 23 and any other components extending downwardly from the body mount 11. More particularly, the drone 10 may include at least one but preferably a pair of landing struts 16 coupled to and extending downwardly and laterally from the body mount 11. Similar to the landing skids of a helicopter, the landing struts 16 enable the drone to land on or adjacent the concrete surface or for use in storage. In an embodiment, the spray bar mount 23 may be directly coupled to the structural elements of the landing struts 16. For example, and such as shown in FIGS. 1a and 5b, a pair of connectors or receivers are coupled to the spray bar mount 23 and each connector is configured to receive one of the landing struts 16 therethrough such that, with the drone 10 resting on the landing struts 16, the spray bar mount 23 is disposed at a lower portion of the landing struts 16 above a lowermost surface of the landing struts 16 and the spray bar mount 23 (and other components attached to the body frame 11) are disposed above the landing struts 16.

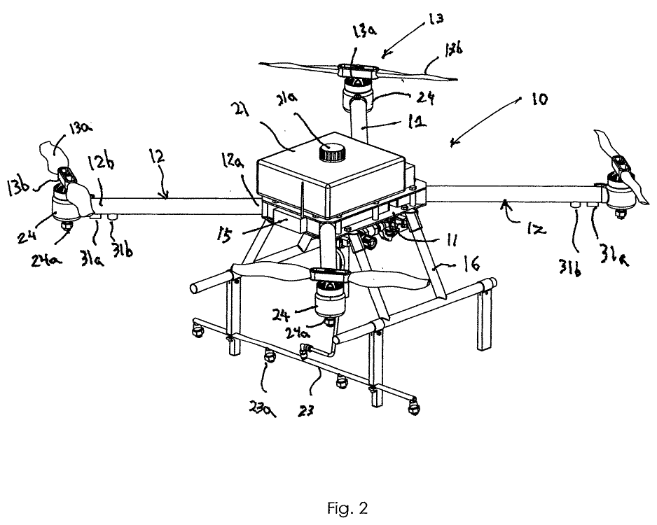

In some examples, legs or feet may extend downwardly from the landing struts 16 and the spray bar mount 23 may be coupled part way along the legs to be elevated from the ground surface when the drone 10 rests on the legs (FIG. 2). That is, the spray bar mount 23 extends between a pair of individual legs and is disposed between the distal ends of the legs and the lower portion of the body frame 11.

According to another aspect, the drone 10 may include a surface finishing assembly including a surface finishing element, such as a concrete broom 40, a float, a rake, and the like, operatively coupled to a rear portion of the body frame 11 via an arm mount 41 or a pair of laterally spaced apart arm mounts of the surface finishing assembly (FIG. 7a). More particularly, each arm mount 41 may include a first end 41a coupled to a rearward portion of landing struts 16. Then, each arm mount 41 may include a second end 41b opposite the first end 41a such that the concrete broom 40 is pulled behind the drone and when the drone 10 is navigated in a forward direction slightly above a concrete surface. The arm mount 41 may position the broom 40 below the landing struts 16 when the drone 10 is flying above the concrete surface.

In an embodiment shown in FIG. 7a, each arm mount 41 may include a generally linear configuration that includes a leveling mechanism 42. More particularly, the arm mount 41 may include a pivot mechanism 42a and an angle adjuster assembly 42b that, together, enable the concrete broom 40 to adjust itself in response to variations in ground surface topography.

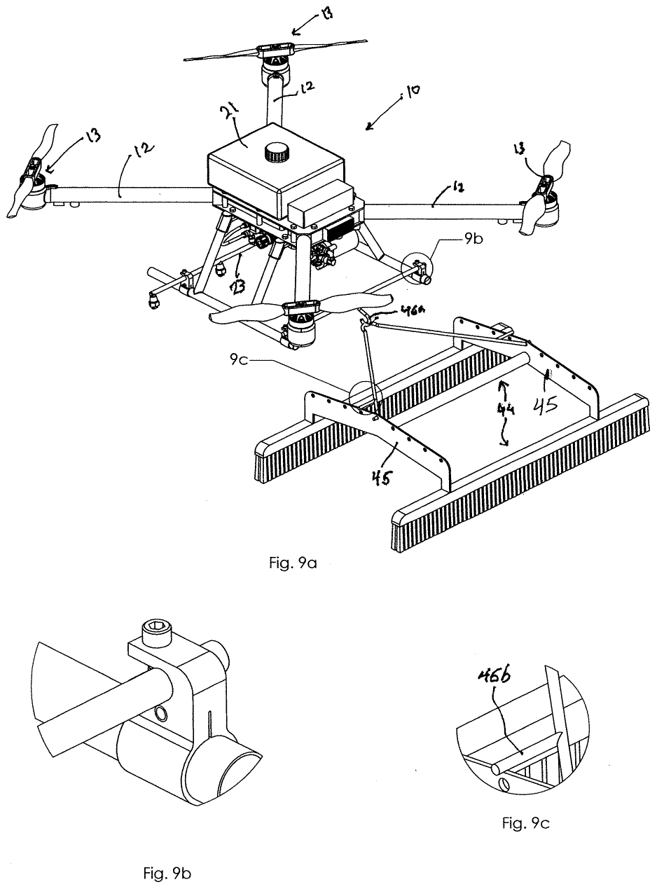

In another embodiment shown in FIG. 9a, the concrete broom 40 includes a pair of concrete brooms 44 positioned parallel to one another and connected together via a pair of connector brackets 45. Preferably, the pair of connector brackets 45 may be coupled to a hook 46a and hook bar 46b that is itself coupled to the pair of landing struts 16 such that the pair of concrete brooms 44 may be pulled forwardly together when the drone 10 is moved in the forward direction.

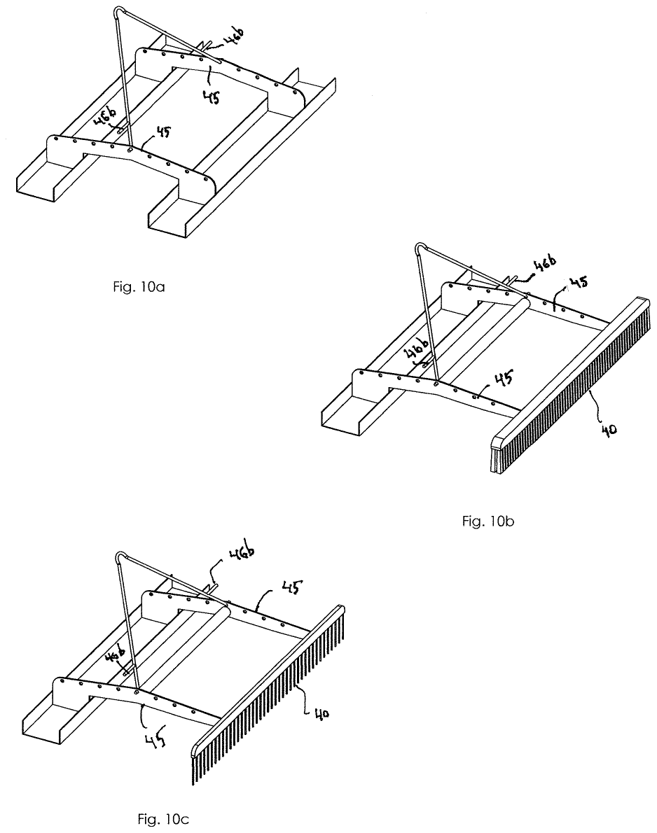

FIGS. 10a to 10c illustrate various arrangements of float pull assemblies being removably coupled to a rear portion of the drone 10 across a concrete surface. A concrete float is a tool used to finish a concrete surface by making it smooth. A float is used after the surface has been made level using a screed. In addition to removing surface imperfections, floating will compact the concrete as preparation for further steps. More particularly, FIG. 10a illustrates a double float pull assembly. FIG. 10b illustrates a float/broom pull assembly, and FIG. 10c illustrates a float/rake assembly in use being pulled by a forwardly moving drone 10. The broom leaves a very light surface texture while the rake leaves grooves in the concrete surface for traction.

An aspect of the disclosure provides a drone for selectively spraying a concrete surface. The drone includes a body frame and a plurality of boom assemblies. Each boom assembly of the plurality of boom assemblies has a proximal end region disposed at the body frame and a distal end region linearly displaced from the proximal end region. Each propulsion member of a plurality of propulsion members is disposed at the distal end region of one respective boom assembly of the plurality of boom assemblies. Each propulsion member of the plurality of propulsion members includes a motor and a propeller. A power source is disposed at the body frame and is operatively connected to the plurality of propulsion members. When the drone is operated to fly above the concrete surface, the power source energizes the plurality of propulsion members to apply lift to the drone. A fluid tank is disposed at the body frame. The fluid tank includes a fill opening in fluid communication with an interior area of the fluid tank. A spray bar includes a plurality of spray nozzles in fluid communication with the fluid tank. When the drone is operated to fly above the concrete surface, the spray bar is disposed at a lower portion of the body frame. Individual spray nozzles of the plurality of spray nozzles are spaced apart from one another at the spray bar. A fluid pump is in data communication with the power source and operatively connected to the plurality of spray nozzles. The fluid pump is configured to actuate the plurality of spray nozzles when energized to spray a fluid from the fluid tank onto the concrete surface. Aspects of the disclosure may include one or more of the following optional features.

In some implementations, the fluid tank may be disposed at an upper portion of the body frame. In further implementations, the body frame may include a perimeter frame portion, and at least a portion of the fluid tank extends inboard of the perimeter frame portion from the upper portion of the body frame toward the lower portion of the body frame. In other further implementations, the fluid pump is disposed at the lower portion of the body frame.

In some examples, the lower portion of the body frame includes a pair of landing struts. The pair of landing struts are configured to rest upon a ground surface when the drone is not being operated to fly above the concrete surface. In further examples, the spray bar is coupled to the pair of landing struts.

In some aspects, the lower portion of the body frame includes a plurality of legs. The spray bar may be coupled to at least one individual leg of the plurality of legs.

In some implementations, the drone further includes a plurality of auxiliary spray nozzles in fluid communication with the fluid tank. Each auxiliary spray nozzle of the plurality of auxiliary spray nozzles may be disposed at the distal end region of one respective boom assembly of the plurality of boom assemblies. The fluid pump may be configured to actuate the plurality of auxiliary spray nozzles when energized.

In some examples, a surface finishing assembly extends from the lower portion of the body frame. The surface finishing assembly may include a surface finishing element that, when the drone is operated to fly above the concrete surface, engages the concrete surface and applies a surface finish to the concrete surface. In further examples, the surface finishing assembly includes a mounting arm having a first end region coupled to the lower portion of the body frame and a second end region coupled to the surface finishing element and distal from the first end region. In even further examples, the surface finishing element is pivotally coupled to the second end region of the mounting arm. With the surface finishing element engaging the concrete surface, the surface finishing element may pivot relative to the second end region of the mounting arm to accommodate variations in the concrete surface. In other even further examples, the surface finishing element includes at least one selected from the group consisting of (i) a broom, (ii) a rake and (iii) a float. In other further examples, when the drone is operated to fly above the concrete surface in a direction of travel, the spray bar is disposed forward of the surface finishing element in the direction of travel.

Another aspect of the disclosure may provide a drone for selectively spraying a concrete surface. The drone includes a body frame, a plurality of boom assemblies, and a plurality of propulsion members. Each boom assembly of the plurality of boom assemblies has a proximal end region disposed at the body frame and a distal end region linearly displaced from the proximal end region. Each propulsion member of the plurality of propulsion members is disposed at the distal end region of one respective boom assembly of the plurality of boom assemblies. Each propulsion member of the plurality of propulsion members includes a motor and a propeller. A power source is disposed at the body frame and is operatively connected to the plurality of propulsion members. When the drone is operated to fly above the concrete surface, the power source energizes the plurality of propulsion members to apply lift to the drone. A fluid tank is disposed at the body frame. The fluid tank includes a fill opening in fluid communication with an interior area of the fluid tank. A broadcast spreader is in fluid communication with the fluid tank. When the drone is operated to fly above the concrete surface, the broadcast spreader is disposed at a lower portion of the body frame. A broadcast motor is in data communication with the power source and operatively connected to the broadcast spreader. The broadcast motor is configured to actuate the broadcast spreader when energized to release a granular material from the fluid tank onto the concrete surface. Aspects of the disclosure may include one or more of the following optional features.

In some implementations, the fluid tank is disposed at an upper portion of the body frame. In further implementations, the body frame includes a perimeter frame portion. At least a portion of the fluid tank extends inboard of the perimeter frame portion from the upper portion of the body frame toward the lower portion of the body frame. In even further implementations, the broadcast spreader and the broadcast motor are coupled to the fluid tank below the lower portion of the body frame.

In some examples, the lower portion of the body frame includes a pair of landing struts. The pair of landing struts are configured to rest upon a ground surface when the drone is not being operated to fly above the concrete surface.

In some aspects, a surface finishing assembly extends from the lower portion of the body frame. The surface finishing assembly includes a surface finishing element that, when the drone is operated to fly above the concrete surface, engages the concrete surface and applies a surface finish to the concrete surface. In further aspects, the surface finishing assembly includes a mounting arm having a first end region coupled to the lower portion of the body frame and a second end region coupled to the surface finishing element and distal from the first end region. In even further aspects, the surface finishing element is pivotally coupled to the second end region of the mounting arm. With the surface finishing element engaging the concrete surface, the surface finishing element pivots relative to the second end region of the mounting arm to accommodate variations in the concrete surface. In other even further aspects, the surface finishing element includes at least one selected from the group consisting of (i) a broom, (ii) a rake and (iii) a float.

In some implementations, a surface finishing assembly is coupled to the lower portion of the body frame. The surface finishing assembly includes (i) a first surface finishing element, (ii) a second surface finishing element spaced from the first surface finishing element, (iii) a connector bracket extending between the first surface finishing element and the second surface finishing element, and (iv) a connector bar extending between the connector bracket and the lower portion of the body frame. When the drone is operated to fly above the concrete surface, the first surface finishing element and the second surface finishing element engage the concrete surface and apply a surface finish to the concrete surface. In further implementations, the first surface finishing element includes a first broom and the second surface finishing element includes a second broom. In further implementations, the first surface finishing element includes a first float and the second surface finishing element includes a second float. In further implementations, the first surface finishing element includes a float and the second surface finishing element includes a broom. In further implementations, the first surface finishing element includes a float and the second surface finishing element includes a rake.

It is understood that while certain forms of this invention have been illustrated and described, it is not limited thereto except insofar as such limitations are included in the following claims and allowable functional equivalents thereof.

1. A drone for selectively spraying a concrete surface, the drone comprising:
a body frame;
a plurality of boom assemblies, each boom assembly of the plurality of boom assemblies having a proximal end region disposed at the body frame and a distal end region linearly displaced from the proximal end region;
a plurality of propulsion members, wherein each propulsion member of the plurality of propulsion members is disposed at the distal end region of one respective boom assembly of the plurality of boom assemblies, and wherein each propulsion member of the plurality of propulsion members comprises a motor and a propeller;
a power source disposed at the body frame and operatively connected to the plurality of propulsion members, wherein, when the drone is operated to fly above the concrete surface, the power source energizes the plurality of propulsion members to apply lift to the drone;
a fluid tank disposed at the body frame, wherein the fluid tank includes a fill opening in fluid communication with an interior area of the fluid tank;
a spray bar including a plurality of spray nozzles in fluid communication with the fluid tank, wherein, when the drone is operated to fly above the concrete surface, the spray bar is disposed at a lower portion of the body frame, and wherein individual spray nozzles of the plurality of spray nozzles are spaced apart from one another at the spray bar; and
a fluid pump in data communication with the power source and operatively connected to the plurality of spray nozzles, wherein the fluid pump is configured to actuate the plurality of spray nozzles when energized to spray a fluid from the fluid tank onto the concrete surface.

2. The drone of claim 1, wherein the fluid tank is disposed at an upper portion of the body frame, and wherein the body frame comprises a perimeter frame portion, and wherein at least a portion of the fluid tank extends inboard of the perimeter frame portion from the upper portion of the body frame toward the lower portion of the body frame.

3. The drone of claim 2, wherein the fluid pump is disposed at the lower portion of the body frame.

4. The drone of claim 1, wherein the lower portion of the body frame comprises a pair of landing struts, and wherein the pair of landing struts are configured to rest upon a ground surface when the drone is not being operated to fly above the concrete surface, and wherein the spray bar is coupled to the pair of landing struts.

5. The drone of claim 1, wherein the lower portion of the body frame comprises a plurality of legs, and wherein the spray bar is coupled to at least one individual leg of the plurality of legs.

6. The drone of claim 1, further comprising a plurality of auxiliary spray nozzles in fluid communication with the fluid tank, wherein each auxiliary spray nozzle of the plurality of auxiliary spray nozzles is disposed at the distal end region of one respective boom assembly of the plurality of boom assemblies, and wherein the fluid pump is configured to actuate the plurality of auxiliary spray nozzles when energized.

7. The drone of claim 1, wherein a surface finishing assembly extends from the lower portion of the body frame, and wherein the surface finishing assembly includes a surface finishing element that, when the drone is operated to fly above the concrete surface, engages the concrete surface and applies a surface finish to the concrete surface.

8. The drone of claim 7, wherein the surface finishing assembly includes a mounting arm having a first end region coupled to the lower portion of the body frame and a second end region coupled to the surface finishing element and distal from the first end region, and wherein the surface finishing element is pivotally coupled to the second end region of the mounting arm, and wherein, with the surface finishing element engaging the concrete surface, the surface finishing element pivots relative to the second end region of the mounting arm to accommodate variations in the concrete surface.

9. The drone of claim 7, wherein the surface finishing element includes at least one selected from the group consisting of (i) a broom, (ii) a rake and (iii) a float.

10. The drone of claim 7, wherein, when the drone is operated to fly above the concrete surface in a direction of travel, the spray bar is disposed forward of the surface finishing element in the direction of travel.

11. The drone of claim 1, wherein a surface finishing assembly is coupled to the lower portion of the body frame, and wherein the surface finishing assembly includes (i) a first surface finishing element, (ii) a second surface finishing element spaced from the first surface finishing element, (iii) a connector bracket extending between the first surface finishing element and the second surface finishing element, and (iv) a connector bar extending between the connector bracket and the lower portion of the body frame, and wherein, when the drone is operated to fly above the concrete surface, at least one selected from the group consisting of (a) the first surface finishing element engages the concrete surface and applies a surface finish to the concrete surface and (b) the second surface finishing element engages the concrete surface and applies the surface finish to the concrete surface.

12. The drone of claim 11, wherein one selected from the group consisting of (i) the first surface finishing element comprises a first broom and the second surface finishing element comprises a second broom, (ii) the first surface finishing element comprises a first float and the second surface finishing element comprises a second float, (iii) the first surface finishing element comprises a float and the second surface finishing element comprises a broom and (iv) the first surface finishing element comprises a float and the second surface finishing element comprises a rake.

13. The drone of claim 1, wherein the spray bar has a linear configuration.

14. A drone for selectively spraying a concrete surface, the drone comprising:
a body frame;
a plurality of boom assemblies, each boom assembly of the plurality of boom assemblies having a proximal end region disposed at the body frame and a distal end region linearly displaced from the proximal end region;
a plurality of propulsion members, wherein each propulsion member of the plurality of propulsion members is disposed at the distal end region of one respective boom assembly of the plurality of boom assemblies, and wherein each propulsion member of the plurality of propulsion members comprises a motor and a propeller;
a power source disposed at the body frame and operatively connected to the plurality of propulsion members, wherein, when the drone is operated to fly above the concrete surface, the power source energizes the plurality of propulsion members to apply lift to the drone;
a fluid tank disposed at the body frame, wherein the fluid tank includes a fill opening in fluid communication with an interior area of the fluid tank;
a broadcast spreader in fluid communication with the fluid tank, wherein, when the drone is operated to fly above the concrete surface, the broadcast spreader is disposed at a lower portion of the body frame; and
a broadcast motor in data communication with the power source and operatively connected to the broadcast spreader, wherein the broadcast motor is configured to actuate the broadcast spreader when energized to release a granular material from the fluid tank onto the concrete surface.

15. The drone of claim 14, wherein the fluid tank is disposed at an upper portion of the body frame, and wherein the body frame comprises a perimeter frame portion, and wherein at least a portion of the fluid tank extends inboard of the perimeter frame portion from the upper portion of the body frame toward the lower portion of the body frame.

16. The drone of claim 15, wherein the broadcast spreader and the broadcast motor are coupled to the fluid tank below the lower portion of the body frame.

17. The drone of claim 14, wherein the lower portion of the body frame comprises a pair of landing struts, and wherein the pair of landing struts are configured to rest upon a ground surface when the drone is not being operated to fly above the concrete surface.

18. The drone of claim 14, wherein a surface finishing assembly extends from the lower portion of the body frame, and wherein the surface finishing assembly includes a surface finishing element that, when the drone is operated to fly above the concrete surface, engages the concrete surface and applies a surface finish to the concrete surface.

19. The drone of claim 18, wherein the surface finishing assembly includes a mounting arm having a first end region coupled to the lower portion of the body frame and a second end region coupled to the surface finishing element and distal from the first end region, and wherein the surface finishing element is pivotally coupled to the second end region of the mounting arm, and wherein, with the surface finishing element engaging the concrete surface, the surface finishing element pivots relative to the second end region of the mounting arm to accommodate variations in the concrete surface.

20. The drone of claim 18, wherein the surface finishing element includes at least one selected from the group consisting of (i) a broom, (ii) a rake and (iii) a float.

21. The drone of claim 14, wherein a surface finishing assembly is coupled to the lower portion of the body frame, and wherein the surface finishing assembly includes (i) a first surface finishing element, (ii) a second surface finishing element spaced from the first surface finishing element, (iii) a connector bracket extending between the first surface finishing element and the second surface finishing element, and (iv) a connector bar extending between the connector bracket and the lower portion of the body frame, and wherein, when the drone is operated to fly above the concrete surface, at least one selected from the group consisting of (a) the first surface finishing element engages the concrete surface and applies a surface finish to the concrete surface and (b) the second surface finishing element engages the concrete surface and applies surface finish to the concrete surface.

22. The drone of claim 21, wherein one selected from the group consisting of (i) the first surface finishing element comprises a first broom and the second surface finishing element comprises a second broom, (ii) the first surface finishing element comprises a first float and the second surface finishing element comprises a second float, (iii) the first surface finishing element comprises a float and the second surface finishing element comprises a broom and (iv) the first surface finishing element comprises a float and the second surface finishing element comprises a rake.
